(19) United States
(12) Patent Application Publication
(10) Pub. No.: US 2006/0219690 A1
(43) Pub. Date: Oct. 5, 2006

(54) Infant warming system

(76) Inventors: Micah Grinstead, Oxford Mills (CA); Christopher R. Skillen, Toronto (CA)

Correspondence Address: Ruth Eure, 4795 Edison Avenue, Boulder, CO, 80301, US

(21) Appl. No.: 11/384,877

(22) Filed: Mar. 20, 2006

Related U.S. Application Data
(60) Provisional application No. 60/663,474, filed on Mar. 18, 2005.

(51) Int. Cl. H05B 1/00; H05B 3/34

(52) U.S. Cl. 219/217; 219/528

(57) ABSTRACT

The present invention provides a warmed contour change pad for providing a soothing environment to change the diaper of an infant. The device comprises a flexible warming film of electrically conductive material, an electrical power supply to supply electrical current to the warming film, a cover, and a controller to control temperature. The device can be battery operated or plugged into a standard wall socket. The cover can be made of terry cloth, fleece or other material. The device can be secured to a dock which can recharge the battery while in place. The device can be portable.

### CLAIM OF PRIORITY

The present invention claims priority from U.S. provisional application 60/663,474, filed Mar. 18, 2005, under 35 USC Section 119(e).

### FIELD OF THE INVENTION

The present invention relates to the field of infant devices, and more particularly to the field of change pads for infants.

### BACKGROUND

The process of crying is more than just a vocalization of discomfort, but a natural response in infants to generate more heat to keep their body warm. The reality is that infants under six months of age are not able to stabilize their body temperature in the same manner as older infants, children and adults. While crying during a change in the day night be tolerable, there is nothing more draining than the dreaded nighttime change. Not only is the crying not pleasant for baby and parent, it also causes the child to be more unsettled and over-stimulated, depriving both the child and parent of much needed sleep.

Therefore, there is a need for providing a more comfortable and soothing environment in which to change the infant This environment will reduce over-stimulation, and enable both the baby and parent to get back to sleep more quickly. Everyone will benefit by getting more rest. Sleep deprivation will be reduced for parents and infants and children. Sleep deprivation can be a risk factor for post partum depression in mothers and illness in infants.

While this is true for human infants, the warmth of the mother is important to most other mammals also. For instance, puppies separated from their mothers would be soothed by gentle warmth. As such, the infant warming system of the present invention can be used for many animals, such as dogs, cats, pigs, and other primates, for example.

The present invention provides an infant warming system. The infant warming system of the present invention may be placed in an infant's room on a suitable table, chest, or other suitable area. Typical indoor ambient temperature range of such rooms is about 18° C.-20° . Objects in the room will assume the ambient temperature and feel cold to the touch. Plastic objects including state of the art change pads may be cold and unpleasant when in contact with the bare back of an infant. The infant is often greatly disturbed when placed on a conventional cold change pad. This problem is obviated by the present invention by providing a warm change pad. The top surface of the pad of the present invention can be warmed to about 28° C.-32° C. which is the emissive temperature range typically measured at the skin surface of a human body. The temperature can be adjusted to suit the needs of different species.

### SUMMARY OF INVENTION

It is an object of the present invention to provide a system which comprises a modified change pad and a warming and control system to form a safe and comfortable infant warming system.

It is a primary object of the present invention to provide a diaper changing system which provides a comfortable temperature for the infant the change process. The parent could therefore expect that the infant will be less disturbed and accordingly less fractious during the change process.

It is a further object of the present invention to provide a heated change pad equipped with a thermal cover for capturing heat and warming diaper changing accessories such as lotion, ointment, wipes, and diapers, for example. This cover can be comprised of any suitable material such as terry cloth, or fleece, or other blanket materials, for example.

In an embodiment, the heated change pad system has two modes. In the open mode the pad is available for the placement of the infant since the thermal cover is placed to one side. In the closed mode the thermal cover is in place and various items such as clothing, lotions, creams, ointments, diapers, wipes, towels, face cloths, bath creams, receiving blankets, pajamas, hats, toys and other items can be warmed on the surface of the pad. The heated change pad is expected to be permanently or removably connected to a source of power since it must be available at all times. It dissipates a very small amount of power since it is most often covered with the thermal cover. It can be plugged into a wall socket, or it can be battery powered. If it is battery powered, the battery can be rechargeable.

It is a further object of the present invention to provide a change pad system comprising a flexible warming film of electrically conductive material and an electrical power supply to supply electrical current to the warming film. The flexible warming film can be between about 25 and 100 microns in thickness.

It is a further object of the present invention to provide a heated change pad comprising flexible warming film of electrically conductive material wherein the flexible warming film of electrically conductive material is sandwiched between at least two layers of insulating material.

It is a further object of the present invention to provide a change pad system comprising a flexible warming film of electrically conductive material wherein the flexible warming film of electrically conductive material is sandwiched between at least two layers of insulating material and the insulating material is polyester film.

It is a further object of the present invention to provide a change pad system comprising a flexible warming film of electrically conductive material and an electrical power supply to supply electrical current to the warming film wherein the power supply comprises a low voltage direct current.

It is a further object of the present invention to provide a change pad system comprising a flexible warming film of electrically conductive material and an electrical power supply to supply electrical current to the warming film wherein the power supply comprises a low voltage alternating current.

It is a further object of the present invention to provide a change pad system comprising a flexible warming film of electrically conductive material and an electrical power supply to supply electrical current to the warming film and additionally further comprising a controller to control temperature. This controller can be a microprocessor or an analog processor. The power supply and controller can comprise means for providing sufficient current and voltage to warm the pad surface, means for detecting and controlling the temperature of the pad surface, means for detecting power faults including over-voltage, over-current, and power supply incompatibility. Such a controller is well known in the art.

It is a further object of the present invention to provide an infant warming system comprising a warming pad which can be secured into a cradle mechanism to lock the pad in place and provide an electrical connection to recharge the system.

The foregoing has outlined the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taking in conjunction with the accompanying drawings, in which:

FIG. 1 depicts the physical arrangement of the present invention;

FIG. 2 depicts a block diagram of a control system which is adapted to work with the present invention; and

FIG. 3 depicts a schematic diagram of a control circuit to supply and control the present invention;

FIG. 4 depicts a sectional embodiment of the present invention;

FIG. 5 depicts a perspective view of the present invention showing safety straps;

FIG. 6 depicts a perspective view of the present invention showing the cover;

FIG. 7 depicts a perspective view of the present invention wherein the flexible warming film is patterned;

FIG. 8 depicts a perspective view of the present invention comprising positioning indicia;

FIG. 9 depicts a perspective view of the present invention illustrating the pad secured to the cradle docking mechanism;

FIG. 10 shows the layer of electrically conductive film sandwiched between two layers of insulating material;

FIG. 11 shows the connection between the wire and the flexible warming film, and

FIG. 12 shows an end view of the present invention illustration the location of batteries.

### BEST MODE FOR CARRYING OUT THE INVENTION

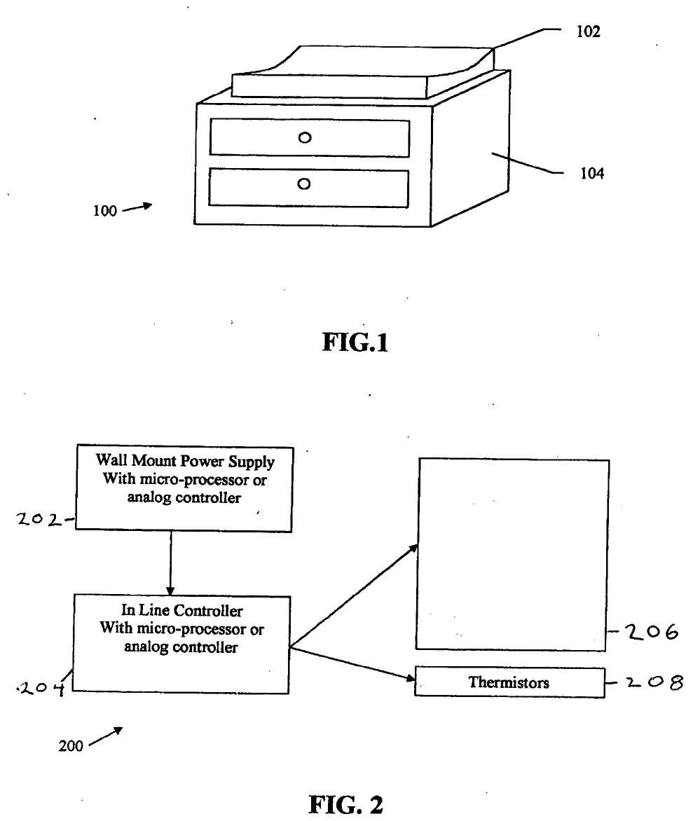

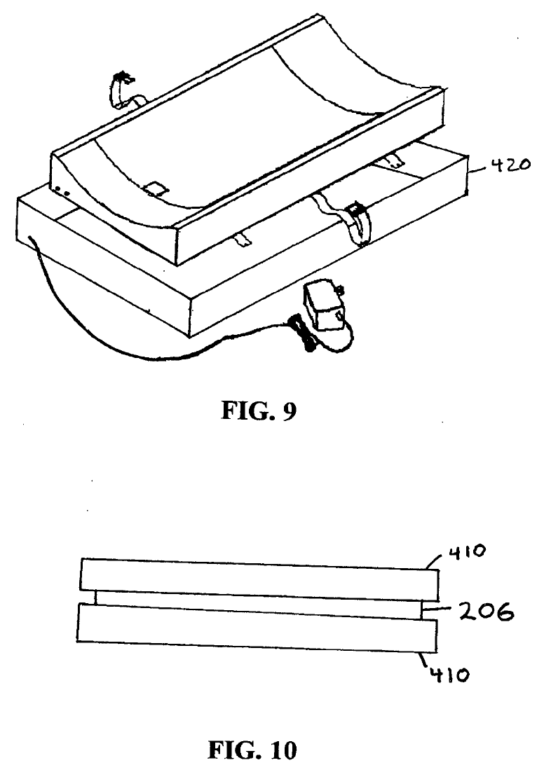

FIG. 1 depicts an exemplary arrangement for the invention. A heated contour change pad 102 is located on a suitable supporting structure 104. Note that shape, size and location of the heated change pad 102 is by way of example only, as a heated change pad could be smaller or larger, and placed in a different location in the house, e.g. in a bedroom (not shown). The heated contour change pad shown may also be located on any suitable surface such as dressers, tables etc. The heated contour change pad may be used in locations other than a house eg., apartment, condo, hotel, motel, hospital, clinic, office building, kindergarten, nursery school, shopping mall or coffeehouse, for example. FIG. 9 shows one embodiment wherein a docking mechanism is secured by screws or other acceptable attachment means to a surface. Dock 420 accepts and secures the warming pad and can provide electrical power to the pad through a set of electrical contacts (not shown).

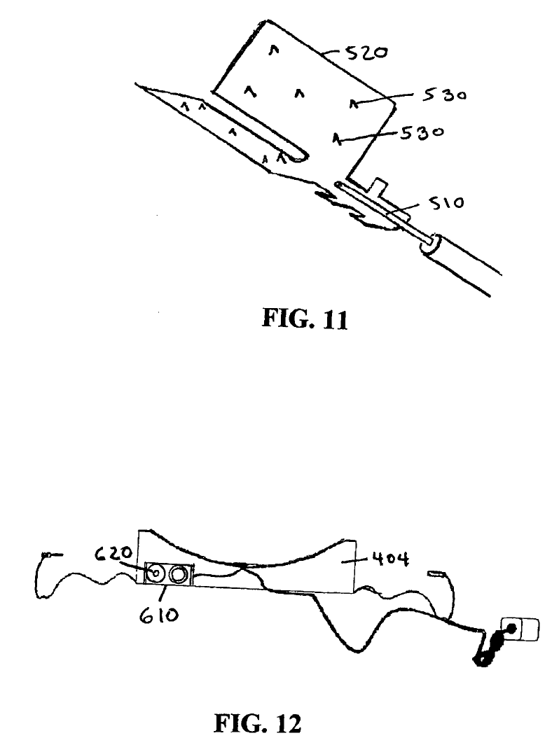

FIG. 2 depicts an embodiment comprising controller 204 used to operate the heated contour change pad. The controller 204 may be located inside the box containing power supply 202, and directly connected to a power cable and plugged into a conventional wall mounted power outlet. The power supply may be permanently attached to the pad by means of sealed connections. Alternatively, the power supply may be removably attached to the change pad system. In an alternative embodiment, controller 204 providing power to the heated contour change pad may be connected in-line into the power cable. In either case, the controller 204 will be able to provide or will be adapted to provide safe temperature control to the electrically conductive film 206. Electrically conductive film 206 comprises a flexible thin film of electrically conductive material such as aluminum foil, copper foil, or aluminum or copper coated film etched to a pattern and sandwiched in a material such as Mylar™, for example. This film is typically about 5 to 10 microns thick. It is important that this electrically conductive film be encased in acid resistant waterproof material, such as polyester film for electrical insulation and isolation. FIG. 10 shows an embodiment, wherein electrically conductive film 206 is sandwiched between two layers of insulating material 410, such as polyester foam example. In an embodiment, polyester or other equivalent material approximately 75 microns thick is laminated with conductive material such as aluminum film approximately 9 microns thick. The elements of this drawing are not drawn to scale. A pattern of etch resistant material can be silk screened, or otherwise printed onto the aluminum. Once the resistive pattern has been produced, a second layer of polyester or other film is adhered to the aluminum creating a layer of insulation as well as providing mechanical strength. This insulation layer may be on the order of 75 microns thick. The size, pattern and resistance of the electrically conductive film are variable. FIG. 11 shows one example of the connection of the wire to the electrically conductive film 206. In FIG. 11, wire end 510 is stripped and tinned and has a clamp 520 soldered onto it. Clamp 520 may be made from tin plated copper, or other suitable material and resembles an open book with small teeth 530 protruding therefrom. Clamp 520 is then closed, like closing a book, around the conductive film and placed under compression. The teeth 530 pierce the polyester outer layers of electrically conductive film 206 and connect to the inner conductive film from both sides.

Whether a special inventive power supply or a conventional supply with a separate inventive controller is used, they can be arranged to control the temperature by using one of two methods. It should be noted that the present invention is not restricted by the architecture of the control system as long as the control system supports the inventive operations as described herein. The two concepts of temperature control adapted from a technique presented herein include an inventive concept and also a concept well known in the art. The controller/power supply 202/204 may obtain temperature information from its ability to monitor the resistive change with temperature change of the electrically conductive film 206 directly with the use of one or more thermistors 208 arranged to provide spot measurement at various points over the surface area of the electrically conductive film 206. Alternatively, the controller power supply 202/204 may obtain temperature information from its ability to monitor the resistive change with temperature change of the electrically conductive film 206 indirectly with the use of one or more thermistors 208 arranged to provide spot measurement at various points over the surface area of the electrically conductive film 206. The system may therefore consist of a microprocessor or an analog controller either of which may be used with the sensor technique involving the electrically conductive film resistance change or thermistor temperature sensors 208. For example, the analog sensor technique could equally be used with any microprocessor provided with an A/D conversion facility. Since the contoured change pad system is used in a relatively hostile environment additional elements and supplements are necessary. For example, the electrically conductive film 206 must be totally sealed within an impermeable sealed cover to prevent contact with moisture from both steam and liquid which could cause corrosion.

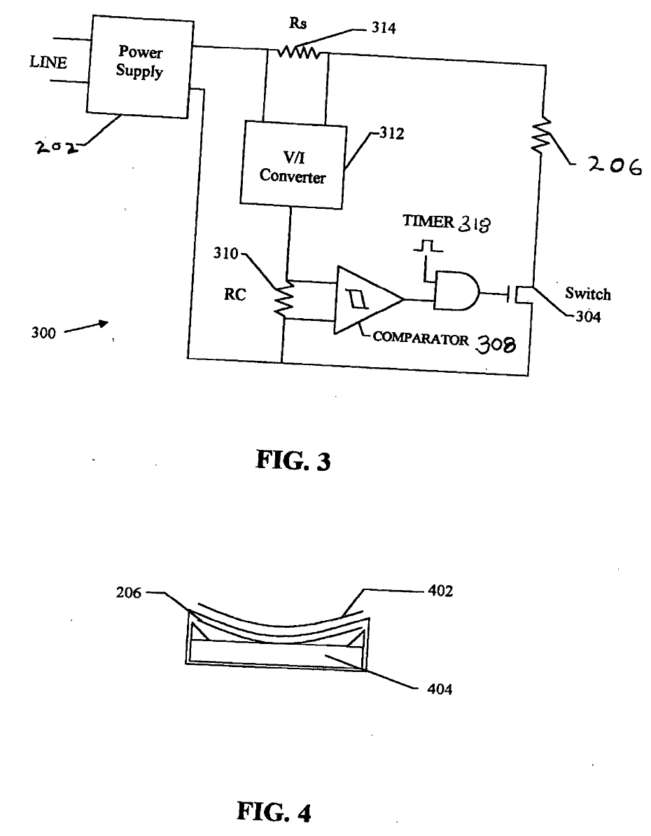

FIG. 3 depicts an analog control circuit arranged to detect, measure and control the electrically conduct film 206 of the change pad 102. An electronic or mechanical switch 304 provides or removes a flow of current to the electrically conductive film 206. This switch 304 is controlled by a logic gate which in turn is provided with control signals by comparator reference 308 and timer 318. The resistor RC 310 provides the comparator reference 308 with a signal that is related to the current ovoid by the V/I converter 312 that senses the current flowing in resistor Rs 314. The timer 318 enables the switch 304 to periodically reconnect power to the electrically conductive film 206. The key advantage of the circuit involves its ability to sense the current changes related to resistance change with temperature experienced by the electrically conductive film 206. A resistance change in excess of a predetermined amount will cause the switch 304 to open. The control circuitry shown may be equally well realized using a microprocessor as described earlier without changing the basic operation. An advantage of the operation described is that the inventive power control circuitry can be built into the power supply without the additional wing related to an actual temperature sensor. The system should also tolerate rapid temperature changes, as well as extremes of high and low temperatures during cleansing, and transportation. Similarly, the heated contour change pad 102 should tolerate extremes of high and low humidity changes, as well as rapid changes in humidity. To achieve these goals multiple layers of protection are provided.

FIG. 4 depicts a cross sectional view of a preferred embodiment of the upper protection layers for the electrically conductive film and the foam base layer 404 that provides a soft surface for baby, protection to the electrically conductive film 206 and also affords flexibility. FIG. 6 shows the thermal cover 402 which is made of soft material such as terry cloth, for example, and is removable for easy washing. Any soft material such as fleece, or other blanket material is also suitable. This cover 402 may also comprise elastic at its periphery to hold it in place. Foam base layer 404 (shown in FIG. 4) may be made of anti-flammable treated polyurethane foam, for example. The cover 402 may be shaped to fit the foam base layer 404.

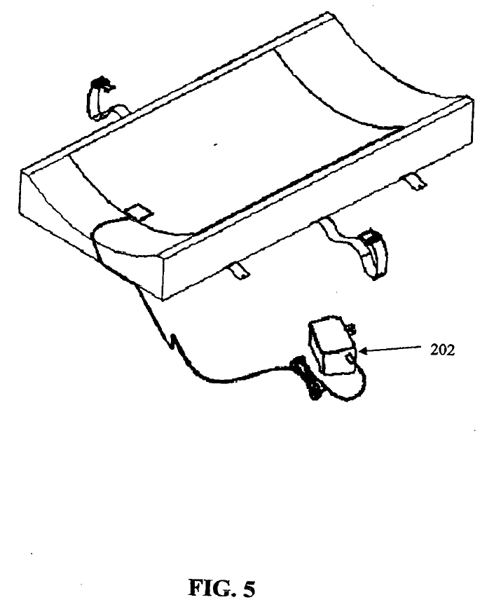

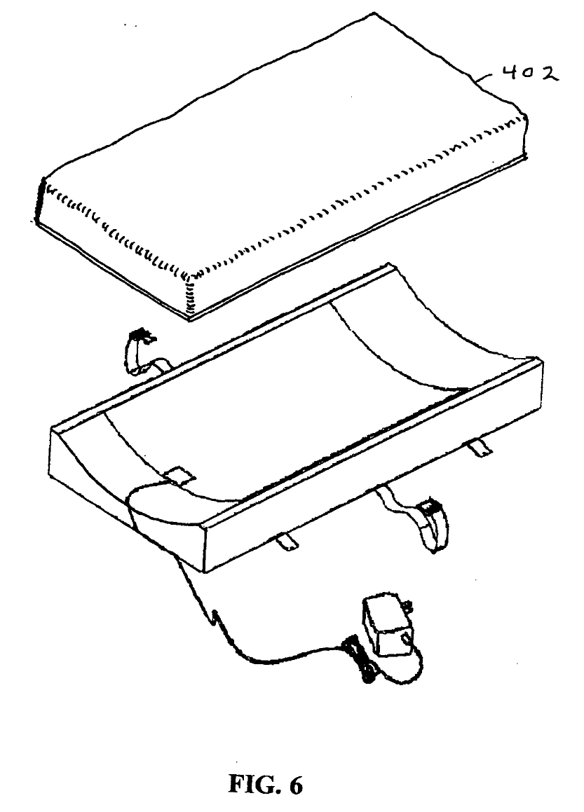

FIG. 5 depicts a perspective view of the heated change pad of the present invention showing the power supply 202. This Figure also shows safety straps for securing an infant to the pad. The safety straps can be secured to the outside of the pad or the foam base layer or to the cover 402. It is contemplated that the straps are attached to the pad away from the electrically conductive film 206.

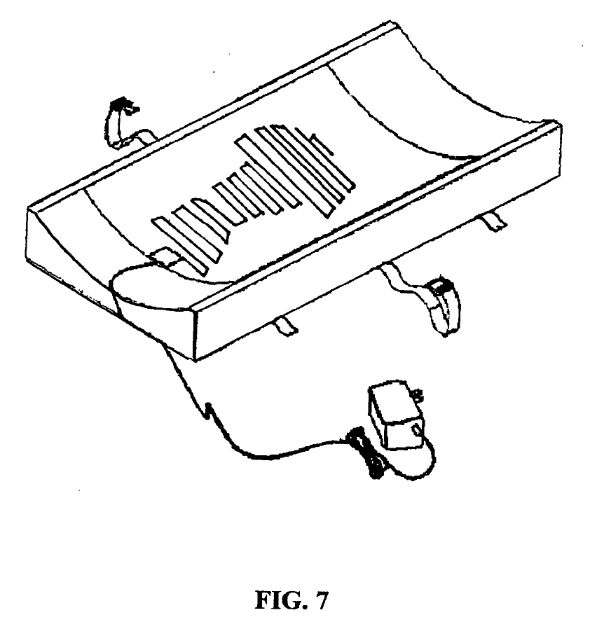

FIG. 7 depicts a perspective view of an alternative embodiment of the present invention further comprising an exemplary pattern to the film. The electrically conductive film can be patterned to create zones of increased warmth.

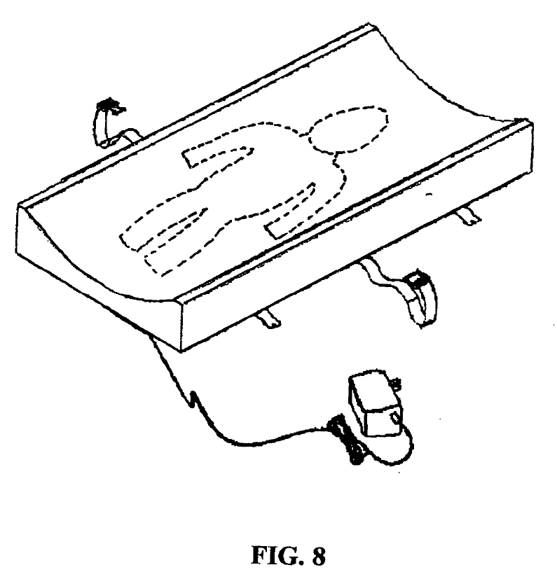

FIG. 8 depicts a perspective view of an alternative embodiment of the present invention wherein the cover comprises a visual guide for placement of the infant. Such positioning indicia may assist in placing the infant in the optimal position for transfer of warmth. The indicia can be the outline of a child as shown, or any other image which would accurately serve the purpose. The indicia can be implemented by stitching in the cover, silkscreen or other printing method, or embossing, or any other method known in the art.

FIG. 12 shows an alternative embodiment of the present invention showing one possible placement for batteries. The batteries are placed into foam base layer 404. One embodiment includes battery case 610 to receive batteries 620. Batteries 620 can be NiMH or Lithium ion batteries, for example. The batteries will charge when electrical power is supplied to the pad. A switch can be accessible on the side of the device to select battery power. This will enable the device to be removed from the wall supply and maintain its functionality.

The description of a contoured change pad does not exclude the possibility of providing the same heating and control system for other shapes of pad. In addition the depiction of solid single electrically conductive film does not exclude the possibility of splitting the eating element into sections to improve its flexibility.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods, or steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, or steps.

What is claimed is:

1. A change pad system comprising:
a flexible warming film of electrically conductive material; and
an electrical power supply to supply electrical current to the warming film.

2. The change pad system of claim 1 further comprising a cover.

3. The change pad system of claim 2 wherein the cover is selected from the group consisting of:
fleece, blanket, or terry cloth.

4. The change pad system of claim 1 wherein:
the flexible warming film of electrically conductive material is sandwiched between at least two layers of insulating material.

5. The change pad system of claim 4 wherein the insulating material is polyester film.

6. The change pad system of claim 1 wherein the power supply comprises a low voltage direct current.

7. The change pad system of claim 1 wherein the power supply comprises a low voltage alternating current.

8. The change pad system of claim 1 further comprising a controller to control temperature.

9. The change pad system of claim 8 wherein the controller is a microprocessor.

10. The change pad system of claim 8 wherein the controller is an analog processor.

11. The change pad system of claim 1 wherein the flexible warming film is patterned.

12. The change pad system of claim 2 wherein the cover comprises positioning indicia.

13. The change pad system of claim 8 wherein the power supply and controller comprise:
means for providing sufficient current and voltage to warm the pad surface;
means for detecting and controlling the temperature of the pad surface;
means for detecting power faults including:
over-voltage,
over-current, and
power supply incompatibility.

14. The change pad system of claim 2 which can also warm accessories such as clothing, lotions, creams, diapers wipes, towels, face cloths, bath creams, receiving blankets, pajamas, hats, toys and other items.

15. The change pad system of claim 1 wherein the power supply comprises a battery.

16. The change pad system of claim 15 wherein the battery is rechargeable.

17. The change pad system of claim 1 which can be docked into a cradle mechanism to lock the pad in place and provide an electrical connection to recharge the system.

18. The change pad system of claim 1 which is portable.

19. The change pad system of claim 1 wherein the flexible warming film is 50 microns or less in thickness.

20. A change pad system comprising:
a flexible warming film of electrically conducive material;
an electrical power supply to supply electrical current to the warming film;
a cover;
a controller to control temperature;
wherein the power supply and controller comprise:
means for providing sufficient current and voltage to heat the pad surface;
means for detecting and controlling the temperature of the pad surface;
means for detecting power faults including:
over-voltage,
over-current, and
power supply incompatibility.
